(19) United States
(12) Patent Application Publication
(10) Pub. No.: US 2010/0328949 A1
(43) Pub. Date: Dec. 30, 2010

(54) ILLUMINATION DEVICE

(75) Inventors: CHIH-MING LAI, Chu-Nan (TW); YU-PIN LIU, Chu-Nan (TW)

Correspondence Address: Altis Law Group, Inc.;ATTN: Steven Reiss, 288 SOUTH MAYO AVENUE, CITY OF INDUSTRY, CA, 91789, US

(73) Assignee: FOXSEMICON INTEGRATED TECHNOLOGY, INC., Chu-Nan (TW)

(21) Appl. No.: 12/702,452

(22) Filed: Feb. 9, 2010

(30) Foreign Application Priority Data
Jun. 26, 2009 (CN) 200910303708.3

(51) Int. Cl. F21S 4/00; F21V 29/00

(52) U.S. Cl. 362/249.02; 362/373

(57) ABSTRACT

An illumination device includes a light source and a heat dissipation device. The light source includes a base and at least a light emitting diode on the base. The heat dissipation device includes a fan for dissipating heat from the light source, and a hollow shell. The hollow shell has an inlet and an outlet defined thereon. The fan is located on the hollow shell, and the airflow from the fan is parallel to a rotation plane of the fan. In operation, air is impelled from the hollow shell by the fan, and heat from the light source is evacuated by airflow from the inlet to the outlet, and air pressure in the shell is reduced. Cool air flows into the hollow shell through the inlet.

### BACKGROUND

1. Technical Field

The present disclosure relates to an illumination device, and particularly, to a light emitting diode (LED) illumination device.

2. Description of Related Art

LEDs are extensively applied due to high brightness, low working voltage, low power consumption, compatibility with integrated circuitry, simple driving operation, long lifetime and other factors.

However, considerable heat is generated by the LED, which, if exceeding a certain limit, such as 120° C., can detrimentally affect working voltage, wavelength and luminous intensity of the LED. Accordingly, heat dissipating fins are often attached to the bottom of the LED light source of the illumination device in a manifold configuration. The generated heat is conducted from the LED toward the fins, and dissipated into the surroundings by natural convection. Nevertheless, hot air between the fins flows very slowly, so considerable heat remains around the LED. If an electric fan is applied to generate forced convection, the fan is usually arranged inside a heat dissipation module or the illumination device, and is difficult to access for removal or maintenance. The entire illumination device may require being disassembled, affecting efficiency and convenience.

Therefore, it is desirable to provide an illumination device which can overcome the described limitations.

### BRIEF DESCRIPTION OF THE DRAWINGS

Many aspects of the disclosure can be better understood with reference to the drawings. The components in the drawings are not necessarily drawn to scale, the emphasis instead being placed upon clearly illustrating the principles of the present image capture device and control method thereof. Moreover, in the drawings, like reference numerals designate corresponding parts throughout the views.

FIG. 1 is a schematic view of an illumination device according to a first embodiment of the present disclosure.

FIG. 2 is an exploded, isometric view of the illumination device shown in FIG. 1.

FIG. 3 is a schematic cross section of an illumination device according to a second embodiment of the present disclosure.

FIG. 4 is a schematic cross section of an illumination device according to a third embodiment of the present disclosure.

FIG. 5 is a schematic cross section of an illumination device according to a fourth embodiment of the present disclosure.

### DETAILED DESCRIPTION

Embodiments of the disclosure will now be described in detail with reference to the accompanying drawings.

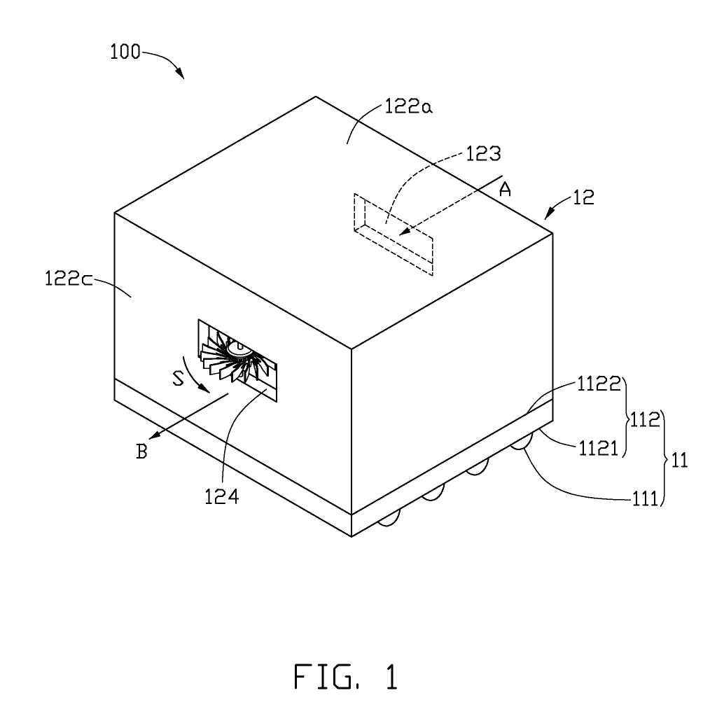

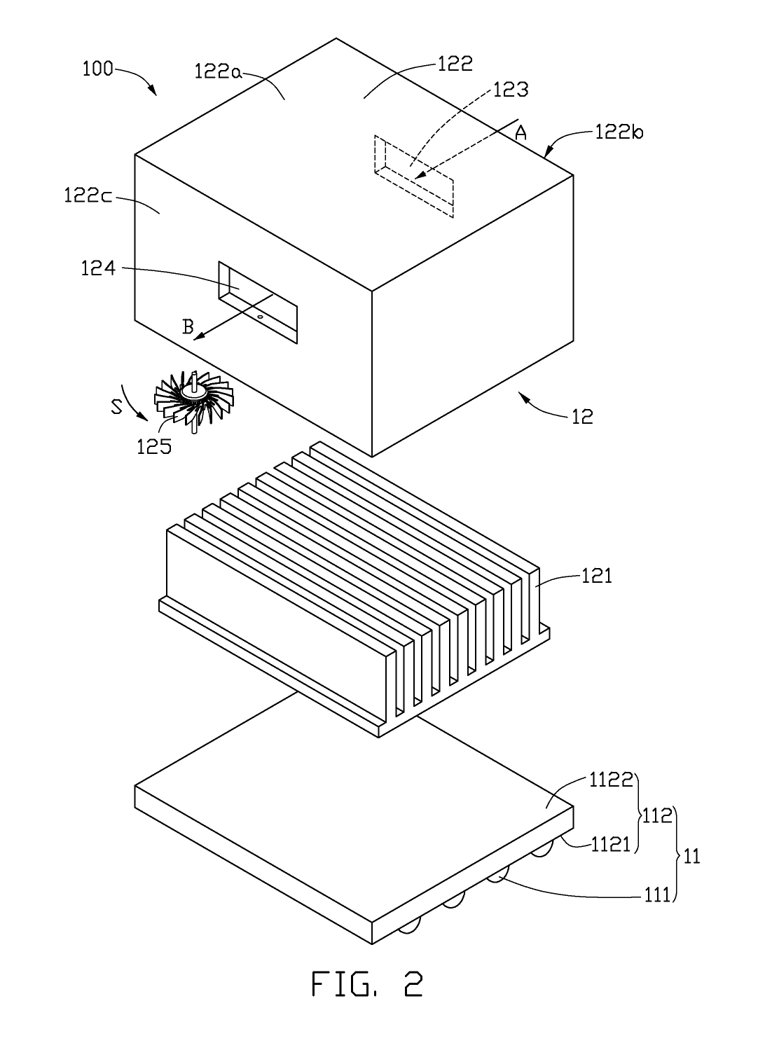

Referring to FIGS. 1-2, an illumination device 100 according to a first embodiment of the present disclosure includes a light source 11 and a heat dissipation device 12. The light source 11 includes a plurality of LEDs 111 and a base 112. The base 112 includes a first surface 1121, and a second surface 1122 opposite thereto. The LEDs 111 are mounted on the first surface 1121 of the base 112, and electrically connected to the base 112.

The heat dissipation device 12 is disposed on the second surface 1122 of the base 112 and thermally connected to the base 112. The heat dissipation device 12 includes a plurality of fins 121, a hollow shell 122 and a fan 125. The fins 121 are received in the hollow shell 122, and thermally connected to the second surface 1122 of the base 112. The hollow shell 122 is detachably fixed on the second surface 1122 of the base 112. The hollow shell 122 includes a top plate 122a, a first sidewall 122b and a second sidewall 122c. Both the first sidewall 122b and the second sidewall 122c are adjacent to the top plate 122a, and the first sidewall 122b and the second sidewall 122c are respectively connected to the opposite sides of the top plate 122a. The hollow shell 122 has an inlet opening 123 defined in the first sidewall 122b thereof and an outlet opening 124 defined in the second sidewall 122c thereof. In this embodiment, the outlet opening 124 is level with the inlet opening 123.

The fan 125 may be disposed in the outlet opening 124, rotatable on a rotation plane S about a rotating axis. An active flow direction B of airflow from the fan 125 is parallel to the rotation plane S of the fan 125. In this embodiment, the airflow from the fan 125 passes through the rotation plane S of the fan 125. In operation, heat generated by the LEDs 111 is outwardly transferred through the fins 121 in the hollow shell 122, and evacuated by the airflow from the fan 125. For example, the active airflow from the fan 125 can substantially flow along the active flow direction B, such that air leaves the hollow shell 122 via outlet opening 124. Since the airflow is strong, air pressure in the hollow shell 122 is reduced and cool air outside the hollow shell 122 quickly enters the hollow shell 122 through the inlet opening 123 along a flow direction A. Airflow speed is increased and convection improved. The airflow from hollow shell 122 is rapidly evacuated, with heat generated by the light source 11 efficaciously dissipated correspondingly.

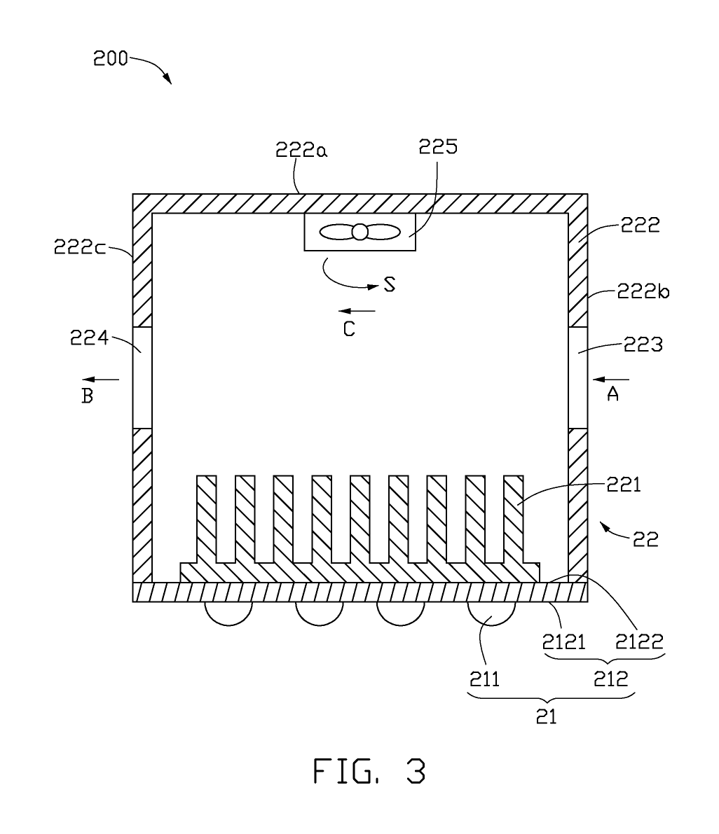

Referring to FIG. 3, an illumination device 200 according to a second embodiment of the present disclosure includes a light source 21 and a heat dissipation device 22. The light source 21 includes a plurality of LEDs 211 and a base 212. The base 212 includes a first surface 2121, and a second surface 2122 opposite thereto. The LEDs 211 are mounted on the first surface 2121 of the base 212, and electrically connected to the base 212.

The heat dissipation device 22 is disposed on the second surface 2122 of the base 212 and thermally connected to the base 212. The heat dissipation device 22 includes a plurality of fins 221, a hollow shell 222 and a fan 225. The fins 221 are received in the hollow shell 222, and thermally connected to the second surface 2122 of the base 212. The hollow shell 222 is detachably fixed on the second surface 2122 of the base 212. The hollow shell 222 includes a top plate 222a, a first sidewall 222b and a second sidewall 222c. Both the first sidewall 222b and the second sidewall 222c are adjacent to the top plate 222a, and the first sidewall 222b and the second sidewall 222c are respectively connected to the opposite sides of the top plate 222a. The hollow shell 222 has an inlet opening 223 defined in the first sidewall 222b thereof and an outlet opening 224 defined in the second sidewall 222c thereof.

In this embodiment, the fan 225 is received in the hollow shell 222 and mounted on an inner surface of the top plate 222a, rotatable on a rotation plane S about a rotating axis. An active flow direction C of airflow from the fan 225 is parallel to the rotation plane S of the fan 225.

In operation of the illumination device 200, heat generated by the LEDs 211 is outwardly transferred through the fins 221 in the hollow shell 222. Air from the hollow shell 222 is impelled by the rotation of the fan 225 along the active flow direction C, and rapidly exits via outlet opening 224 along the active flow direction B. Since the airflow is strong, air pressure in the hollow shell 222 is reduced, and cool air from outside the hollow shell 222 quickly enters the hollow shell 222 through the inlet opening 223 along a flow direction A. Airflow speed is increased and convection improved. The airflow from hollow shell 222 is rapidly evacuated, with heat generated by the light source 21 efficaciously dissipated correspondingly.

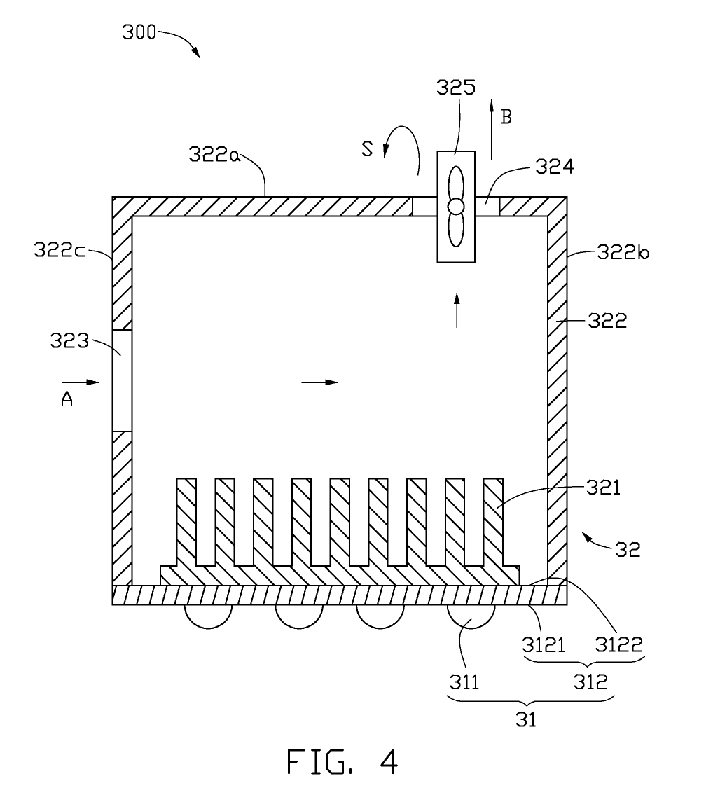

Referring to FIG. 4, an illumination device 300 according to a third embodiment of the present disclosure includes a light source 31 and a heat dissipation device 32. The light source 31 includes a plurality of LEDs 311 and a base 312. The base 312 includes a first surface 3121, and a second surface 3122 opposite to the first surface 3121. The LEDs 311 are mounted on the first surface 3121 of the base 312, and electrically connected to the base 312.

The heat dissipation device 32 is disposed on the second surface 3122 of the base 312 and thermally connected to the base 312. The heat dissipation device 32 includes a plurality of fins 321, a hollow shell 322 and a fan 325. The fins 321 are received in the hollow shell 322, and thermally connected to the second surface 3122 of the base 312. The hollow shell 322 is detachably fixed on the second surface 3122 of the base 312. The hollow shell 322 includes a top plate 322a, a first sidewall 322b and a second sidewall 322c. Both the first sidewall 322b and the second sidewall 322c are adjacent to the top plate 322a, and the first sidewall 322b and the second sidewall 322c are respectively connected to the opposite sides of the top plate 322a. The hollow shell 322 has an inlet opening 323 defined in the second sidewall 322c thereof and an outlet opening 324 defined in the top plate 322a thereof. The fan 325 is disposed in the outlet opening 324. The inlet opening 323 is located below the outlet opening 324.

The fan 325 is rotatable on a rotation plane S about a rotating axis. An active flow direction B of airflow from the fan 325 is parallel to the rotation plane S of the fan 325. It is understood that the position of the fan 325 may be adjusted. For instance, the fan 325 may be disposed in the inlet opening 323.

In operation of the illumination device 300, heat generated by the LEDs 311 is outwardly transferred through the fins 321 in the hollow shell 322, and evacuated by the active airflow from the fan 325. For example, the active airflow from the fan 325 can substantially flow along the active flow direction B, such that air exits the hollow shell 322 via outlet opening 324. Since the airflow flows out quickly from the hollow shell 322, air pressure in the hollow shell 322 is reduced, and cool air outside the hollow shell 322 quickly enters the hollow shell 322 through the inlet opening 323 along a flow direction A. The cool air flows toward the working LEDs 311 in the hollow shell 322, and evacuates generated heat through the outlet openings 324. As a result, stable airflow is established throughout the hollow shell 322, and the heat-dissipating efficiency is increased.

As mentioned, the inlet opening 323 is disposed on the second sidewall 322c of the hollow shell 322, and the outlet opening 324 is disposed on the top plate 322a of the hollow shell 322. Since the inlet opening 323 is located below the outlet opening 324, it is easier for the cool air to enter the shell 322 via the inlet opening 323 and the heated air to leave the shell 322 via the outlet opening 324, according to the natural air convention. Thus, heat-dissipating efficiency is further improved in cooperation with the natural convection through the arranged flow path and the forced convection by the fan 325.

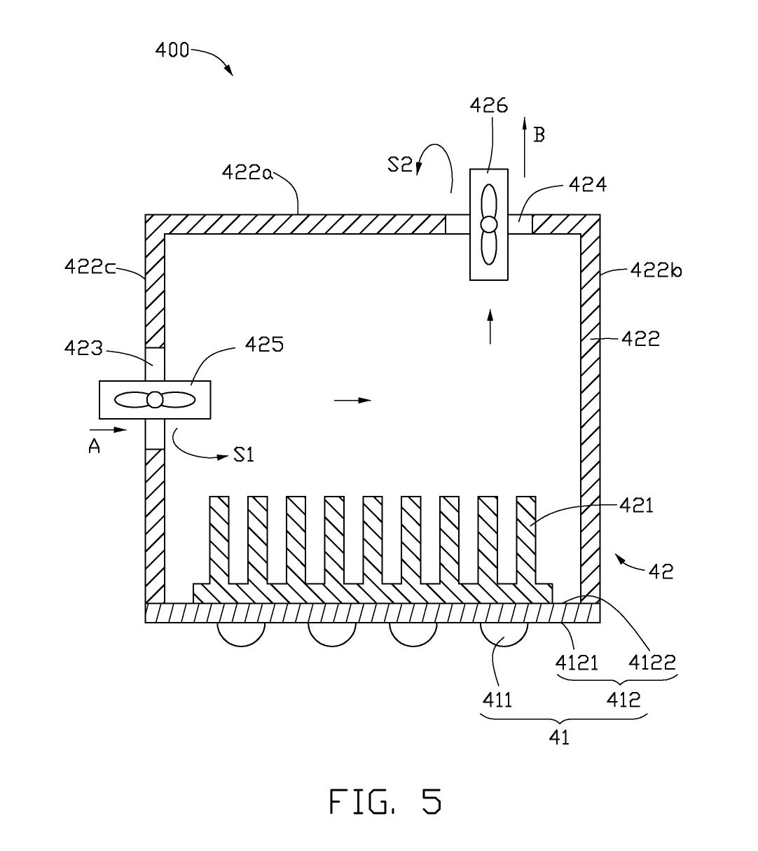

Referring to FIG. 5, an illumination device 400 according to a fourth embodiment of the present disclosure includes a light source 41 and a heat dissipation device 42. The light source 41 includes a plurality of LEDs 411 and a base 412. The base 412 includes a first surface 4121, and a second surface 4122 opposite to the first surface 4121. The LEDs 411 are mounted on the first surface 4121 of the base 412, and electrically connected to the base 412.

The heat dissipation device 42 is disposed on the second surface 4122 of the base 412 and thermally connected to the base 412. The heat dissipation device 42 includes a plurality of fins 421, a hollow shell 422, a first fan 425 and a second fan 426. The fins 421 are received in the hollow shell 422, and thermally connected to the second surface 4122 of the base 412. The hollow shell 422 is detachably fixed on the second surface 4122 of the base 412. The hollow shell 422 includes a top plate 422a, a first sidewall 422b and a second sidewall 422c. Both the first sidewall 422b and the second sidewall 422c are adjacent to the top plate 422a, and the first sidewall 422b and the second sidewall 422c are respectively connected to the opposite sides of the top plate 422a. The hollow shell 422 has an inlet opening 423 defined in the second sidewall 422c thereof and an outlet opening 424 defined in the top plate 422a thereof.

In this embodiment, the first fan 425 is disposed in the inlet opening 423; and the second fan 426 is disposed in the outlet opening 424. The first fan 425 is rotatable in a rotation plane S1 about a rotating axis; and the second fan 426 is rotatable on a rotation plane S2 about another rotating axis.

In operation of the illumination device 400, heat generated by the LEDs 411 is outwardly transferred through the fins 421 in the hollow shell 422, and can be evacuated by the active airflow from the second fan 426. For example, the active airflow from the second fan 426 can substantially flow along the active flow direction B, such that air leaves the hollow shell 422 via outlet opening 424. Since the airflow is strong, air pressure in the hollow shell 422 is reduced, and cool air from outside quickly enters the hollow shell 422 through the inlet opening 423 along flow direction A. In addition, air is further impelled from the inlet opening 423 to the outlet opening 424 by the rotation of the first fan 425. As a result, heat generated by the LEDs 411 is rapidly evacuated through the outlet openings 424.

It is understood that the fan or fans may be disposed in the outlet opening as shown in the first embodiment of the present invention, in the inlet opening for accelerating airflow through the inlet opening, or in both the inlet opening and the outlet opening for accelerating airflow through both the inlet opening and the outlet opening.

It is to be understood, however, that even though numerous characteristics and advantages of various embodiments have been set forth in the foregoing description, together with details of the structures and functions of the embodiments, the disclosure is illustrative only; and that changes may be made in detail, especially in matters of arrangement of parts within the principles of the invention to the full extent indicated by the broad general meaning of the terms in which the appended claims are expressed.

What is claimed is:

1. An illumination device, comprising:
a light source comprising:
a base comprising a first surface and a second surface; and
a light emitting diode disposed on the first surface of the base; and
a heat dissipation device, the heat dissipation device comprising:
a fan for dissipating heat generated from the light source, rotatable on a rotation plane about a rotating axis; and
a hollow shell detachably fixed on the base and receiving the fan therein, the hollow shell comprising an inlet opening and an outlet opening, wherein airflow from the fan is parallel to the rotation plane of the fan and the airflow enters the hollow shell via the inlet opening and leaves the hollow shell via the outlet opening to thereby take the heat away from the light source.

2. The illumination device of claim 1, wherein the heat dissipation device further comprises a plurality of fins disposed on the second surface of the base in the hollow shell.

3. The illumination device of claim 1, wherein the hollow shell comprises a top plate, a first sidewall on which the inlet opening is disposed and a second sidewall on which the outlet opening is disposed.

4. The illumination device of claim 1, wherein the fan is disposed in one of the inlet opening and the outlet opening.

5. The illumination device of claim 3, wherein the heat dissipation device further comprises an additional fan, the fan and the additional fan being disposed in the inlet opening and the outlet opening, respectively.

6. The illumination device of claim 3, wherein the fan is disposed in the hollow shell on a surface of the top plate.

7. The illumination device of claim 1, wherein the hollow shell has a top plate, a first sidewall and a second sidewall, disposed on opposite sides of the top plate, and wherein the inlet opening is disposed on the second sidewall and the outlet opening is disposed in the top plate.

8. The illumination device of claim 7, wherein the fan is disposed in one of the inlet opening and the outlet opening.

9. The illumination device of claim 7, wherein the heat dissipation device further comprises an additional fan, the fan and the additional fan being disposed in the inlet opening and the outlet opening, respectively.

10. The illumination device of claim 1, wherein an opening direction of the inlet opening is parallel with an opening direction of the outlet opening.

11. The illumination device of claim 1, wherein an opening direction of the inlet opening is perpendicular to an opening direction of the outlet opening.

12. The illumination device of claim 1, wherein the inlet opening is located below the outlet opening.

13. An illumination device, comprising:
a light source comprising a base and a plurality of light emitting diodes mounted on the base;
a shell detachably fixed on the base and opposite to the light emitting diodes, the shell defining an inlet opening and an outlet opening therein;
a plurality of fins received in the shell and thermally connecting to the base of the light source; and
at least a fan rotatably received in the shell for cooling the fins;
wherein airflow from the fan passing through at least one of the inlet opening and outlet opening of the shell is parallel to a rotation plane of the fan.

14. The illumination device of claim 13, wherein the inlet opening is level with the outlet opening.

15. The illumination device of claim 13, wherein the inlet opening is below the outlet opening.
